(19) United States
(12) Patent Application Publication
(10) Pub. No.: US 2026/0219206 A1
(43) Pub. Date: Jul. 30, 2026

(54) IMAGE BRIGHTNESS CORRECTION MODULE AND OPTICAL INSPECTION APPARATUS INCLUDING THE SAME

(71) Applicant: Samsung Electronics Co., Ltd., Suwon-si (KR)

(72) Inventors: Jihoon Park, Suwon-si (KR); Kwangwun Han, Suwon-si (KR)

(21) Appl. No.: 19/264,987

(22) Filed: Jul. 10, 2025

(30) Foreign Application Priority Data
Nov. 26, 2024 (KR) 10-2024-0171455

(51) Int. Cl. G01N 21/95; G01N 21/88

(52) U.S. Cl. CPC G01N 21/9501; G01N 21/8806; G01N 21/8851; G01N 2201/121

(57) ABSTRACT

An image brightness correction module includes a representative brightness value calculator configured to calculate a representative brightness value for a captured image of a device under inspection, a brightness value corrector configured to correct the representative brightness value so that a difference between the representative brightness value and a preset reference brightness value is within a certain range, and a corrected image generator configured to form a corrected image having the final brightness value, wherein a brightness value of the captured image is corrected to the final brightness value. The representative brightness value represents a grayscale level value at an extreme point in a histogram of the captured image. In the histogram, an x-axis represents a grayscale level value of the captured image and a y-axis represents a number of pixels corresponding to the grayscale level value.

### CROSS-REFERENCE TO RELATED APPLICATION

This application is based on and claims priority under 35 U.S.C. § 119 to Korean Patent Application No. 10-2024-0171455, filed on Nov. 26, 2024, in the Korean Intellectual Property Office, the disclosure of which is incorporated by reference herein in its entirety.

### BACKGROUND

The inventive concept relates to an image brightness correction module and an optical inspection apparatus including the image brightness correction module.

In semiconductor manufacturing processes, optical inspection apparatuses are used to inspect the quality of produced semiconductor devices. An optical inspection apparatus emits light onto a semiconductor device by means of a lighting tool and analyzes an image captured by using reflected light, thereby detecting defects in the semiconductor device. During the optical inspection, it is important to keep brightness of the image constant for accurate detection of defects, and thus image brightness correction techniques are being utilized.

### SUMMARY

The inventive concept provides an optical inspection apparatus capable of adjusting brightness of a captured image of a device under inspection, i.e., a semiconductor substrate.

Also, the objects of the inventive concept are not limited to the aforementioned object, but other objects not described herein will be clearly understood by those skilled in the art from the following description.

According to an aspect of the inventive concept, there is provided an image brightness correction module including a representative brightness value calculator configured to calculate a representative brightness value for a captured image of a device under inspection, a final brightness value calculator configured to adjust the representative brightness value so that a difference between the representative brightness value and a preset reference brightness value is within a certain range, and to calculate a final brightness value of the captured image, and a corrected image generator configured to form a corrected image having the final brightness value, wherein a brightness value of the captured image is corrected to the final brightness value, wherein the representative brightness value represents a grayscale level value at an extreme point in a histogram of the captured image, and in the histogram, an x-axis represents a grayscale level value of the captured image and a y-axis represents a number of pixels corresponding to the grayscale level value of the captured image.

According to another aspect of the inventive concept, there is provided an optical inspection apparatus including a light source unit configured to emit light, an optical unit configured to guide the light from the light source unit to a device under inspection, an image capturing unit configured to obtain a captured image of the device under inspection by using light reflected from the device under inspection, a controller configured to control operations of the light source unit and the image capturing unit, and a processor configured to generate a histogram of the captured image obtained by the image capturing unit, detect an extreme point, at which a slope changes in the histogram, to set the extreme point as a representative brightness value, and, based on a difference between the representative brightness value and a preset reference brightness value, correct brightness of the captured image, wherein the representative brightness value represents a grayscale level value at the extreme point in the histogram of the captured image.

According to another aspect of the inventive concept, there is provided an optical inspection apparatus including a light source unit configured to emit light, an optical unit configured to guide the light from the light source unit to a device under inspection, a stage configured to support the device under inspection, an image capturing unit configured to obtain a captured image of the device under inspection by using light reflected from the device under inspection, a controller configured to control operations of the light source unit, the stage, and the image capturing unit, and a processor configured to process the captured image obtained by the image capturing unit, wherein the processor includes a histogram generator configured to generate a histogram from the captured image, a noise eliminator configured to eliminate noise from the histogram, a derivative calculator configured to calculate a derivative for the histogram from which the noise has been eliminated, a representative brightness value-setting unit configured to set, as a representative brightness value, one of x values for which y values are zero in a graph for the derivative, a comparator configured to compare the representative brightness value to a reference brightness value, a final brightness value-setting unit configured to set the representative brightness value as a final brightness value when a difference between the representative brightness value and the reference brightness value is within a certain range, and a corrected image generator configured to form a corrected image having the final brightness value, wherein a brightness value of the captured image is set to the final brightness value, wherein the representative brightness value represents a grayscale level value at an extreme point in the histogram of the captured image, and in the histogram, an x-axis represents a grayscale level value of the captured image and a y-axis represents a number of pixels corresponding to the grayscale level value of the captured image.

### BRIEF DESCRIPTION OF THE DRAWINGS

Embodiments will be more clearly understood from the following detailed description taken in conjunction with the accompanying drawings in which:

FIG. 1 is a block diagram schematically showing an image brightness correction module according to an example embodiment;

FIG. 2 is a block diagram schematically showing an example of a representative brightness value calculator illustrated in FIG. 1;

FIG. 3 is a block diagram schematically showing an example of a brightness value corrector illustrated in FIG. 1;

FIG. 4 is an example of a captured image obtained by an optical inspection apparatus;

FIG. 5 is a graph showing a histogram of the captured image illustrated in FIG. 4;

FIG. 6 is a histogram graph obtained by eliminating noise from the histogram graph shown in FIG. 5;

FIG. 7 is a histogram graph obtained by eliminating noise from the histogram graph shown in FIG. 6;

FIG. 8 shows a derivative graph of the histogram graph shown in FIG. 7;

FIG. 9 is a block diagram schematically showing an optical inspection apparatus according to an example embodiment;

FIG. 10A is a captured image obtained by an optical inspection apparatus;

FIG. 10B shows a histogram graph of the captured image illustrated in FIG. 10A and a derivative graph of the histogram graph;

FIG. 11A is a corrected captured image obtained by correcting brightness values in the captured image shown in FIG. 10A;

FIG. 11B shows a histogram graph of the captured image illustrated in FIG. 11A and a derivative graph of the histogram graph;

FIG. 12A is a corrected captured image obtained by correcting brightness values in the captured image shown in FIG. 11A;

FIG. 12B shows a histogram graph of the captured image illustrated in FIG. 12A and a derivative graph of the histogram graph; and

FIG. 13 is a flowchart schematically showing an image brightness correction method according to an example embodiment.

### DETAILED DESCRIPTION OF THE EMBODIMENTS

Hereinafter, embodiments are described in detail with reference to the accompanying drawings. The inventive concept may, however, be embodied in different forms and should not be construed as limited to the embodiments set forth herein. The following embodiments are provided to sufficiently convey the scope of the inventive concept to those skilled in the art rather than to make the inventive concept thorough and complete. Like reference characters refer to like elements throughout.

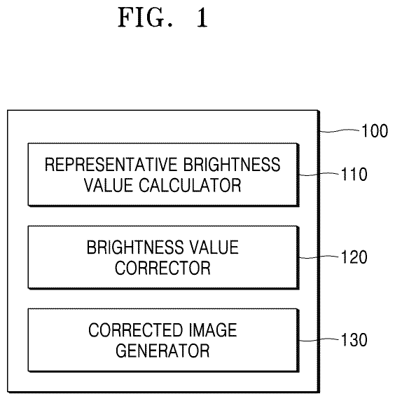

FIG. 1 is a block diagram schematically showing an image brightness correction module 100 according to an example embodiment.

Referring to FIG. 1, the image brightness correction module 100 according to an embodiment may include a representative brightness value calculator 110, a brightness value corrector 120, and a corrected image generator 130.

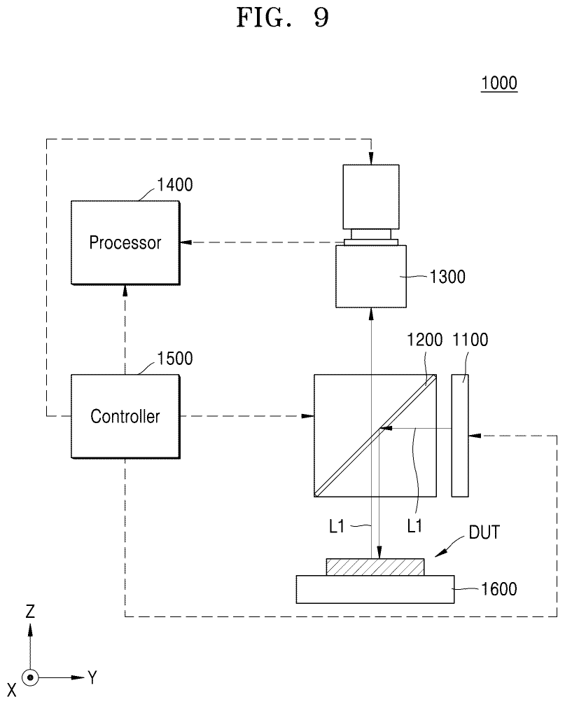

The representative brightness value calculator 110 may calculate a representative brightness value of a captured image of a device under inspection. Specifically, the representative brightness value calculator 110 may calculate a representative brightness value for a captured image of a device under inspection (e.g., device under inspection (DUT) of FIG. 9) obtained by an optical inspection apparatus 1000 (e.g., optical inspection apparatus 1000 of FIG. 9).

The optical inspection apparatus 1000 may non-destructively inspect a device under inspection DUT. The optical inspection apparatus 1000 may include a vision automatic inspection device that generates an image of the appearance and shape of the device under inspection DUT and processes the image to determine whether or not the device under inspection DUT is aligned or defective. According to embodiments, the optical inspection apparatus 1000 may inspect devices under inspection DUT at a high speed, which may increase productivity of the devices under inspection DUT and reliability of the inspection thereof. The optical inspection apparatus 1000 is described below with reference to FIG. 9.

The device under inspection DUT may include a semiconductor chip on which packaging processes have been performed. The packaging processes may include, for example, a wire bonding process, a molding process, a marking process, a solder ball mount process, and the like. The device under inspection DUT may include an individualized package or a wafer-level package.

The device under inspection DUT may include, for example, any one of a memory device chip and a non-memory device chip. According to some embodiments, the memory device may include non-volatile NOT-AND (NAND)-type flash memory. According to some embodiments, the memory device may include phase-change random access memory (PRAM), magnetic random access memory (MRAM), resistive RAM (ReRAM), ferroelectric random access memory (FRAM), NOT-OR (NOR) flash memory, and the like. The memory device may also include a volatile memory device, such as the DRAM and SRAM, in which data is lost when power is removed. According to some embodiments, the device under inspection DUT may include a logic chip, an instrumentation device, a communication device, a digital signal processor (DSP), or a system-on-chip (SOC).

The image brightness correction module 100 may receive, from the optical inspection apparatus 1000, a captured image of the device under inspection DUT obtained by the optical inspection apparatus 1000, and the representative brightness value calculator 110 of the image brightness correction module 100 may calculate a representative brightness value of the captured image of the device under inspection DUT. The representative brightness value calculator 110 may generate a histogram for the captured image and set, as a representative brightness value, a grayscale level value at an extreme point of the histogram. A histogram is a graph in which an x-axis represents a grayscale level value of the captured image and a y-axis represents the number of pixels corresponding to the grayscale level value.

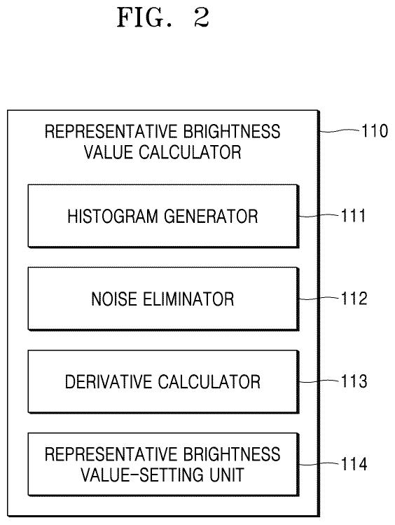

FIG. 2 is a block diagram schematically showing an example of a representative brightness value calculator 110 illustrated in FIG. 1.

Referring to FIG. 2, the representative brightness value calculator 110 may include, for example, a histogram generator 111, a noise eliminator 112, a derivative calculator 113, and a representative brightness value-setting unit 114.

The histogram generator 111 may generate a histogram from the captured image that is received from the optical inspection apparatus 1000. For example, the histogram generator 111 may generate a histogram that shows distribution of brightness values per pixels in the captured image. In the histogram, the horizontal axis may represent brightness values (0-255) and the vertical axis may represent the number of pixels having the corresponding brightness values.

The histogram generator 111 may generate a histogram by using, for example, a calcHist( ) function of an OpenCV library. The calcHist( ) function may receive, as input parameters, image data, a histogram dimension, a channel index, a mask, a histogram size, and a range of brightness values. Since the embodiment involves grayscale images, the one-dimensional histogram may be generated and the channel index may be set to zero.

The histogram generator 111 may first convert the captured image to a grayscale. This may be performed by using a cvtColor( ) function of OpenCV to convert an RGB image to the grayscale. Each pixel in the converted grayscale image may have a brightness value between about 0 and about 255.

Subsequently, the histogram generator 111 may set a brightness value interval. In the embodiment, 256 intervals (bins) may be set to ensure that the exact number of pixels for each brightness value is identified. The brightness value range may be set from about 0 to about 255.

The histogram generator 111 may identify a brightness value for every pixel in the grayscale image and may increase a count of the corresponding bin by one. This may be automatically performed inside the calcHist( ) function.

The generated histogram may be formed as a one-dimensional array having 256 elements, and each of the elements may store the number of pixels having a corresponding brightness value. For example, the 50th element in the histogram may represent the number of pixels having a brightness value of 50.

The histogram generator 111 may normalize the generated histogram. The normalization may be performed by using a normalize( ) function of OpenCV, which may allow for consistent histogram analysis regardless of image size. Each element in the normalized histogram may have a value between about 0 and about 1.

The generated histogram may be sent to the noise eliminator 112 and subjected to subsequent processing. The noise eliminator 112 may remove unnecessary fluctuations in the histogram and thus help to find meaningful peak points and extreme points.

The noise eliminator 112 may eliminate noise from the histogram that has been received from the histogram generator 111. Noise may represent unnecessary sharp changes or small fluctuations in the histogram, and this noise may interfere with accurate detection of extreme points.

The noise eliminator 112 may utilize a moving average technique to eliminate the noise from the histogram. The moving average technique may be one of the smoothing techniques that are used to average data over a certain bin in time series data to create a smooth curve.

In the moving average technique, the noise eliminator 112 may set a window size. The window size may represent the number of pieces of data that are used when calculating the average. In the embodiment, the window size may be set to 3, which indicates that the average may be calculated with data that includes one piece of data on the left and one piece of data on the right around a current location.

At each location of brightness values in the histogram, the noise eliminator 112 may calculate an average of the values in a window around the corresponding location. For example, a new value at the location of brightness value 100 may be the average of values at the locations of brightness values 99, 100, and 101.

When a window falls outside a boundary of the histogram, the noise eliminator 112 may calculate an average by using only values within the boundary. For example, at a location of brightness value 1, the average may be calculated by using only values at locations of brightness values 0, 1, 2, and 3.

The noise eliminator 112 may repeatedly perform moving average calculations several times. The number of repetitions may be adjusted depending on the level of noise and the desired degree of smoothing.

A histogram that has undergone moving average processing may have a smooth curve with less sharp changes. This may improve the accuracy of subsequent derivative calculation and extreme point detection.

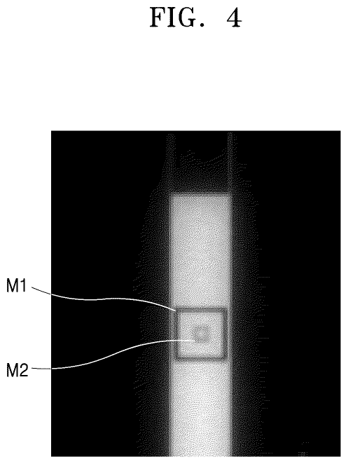

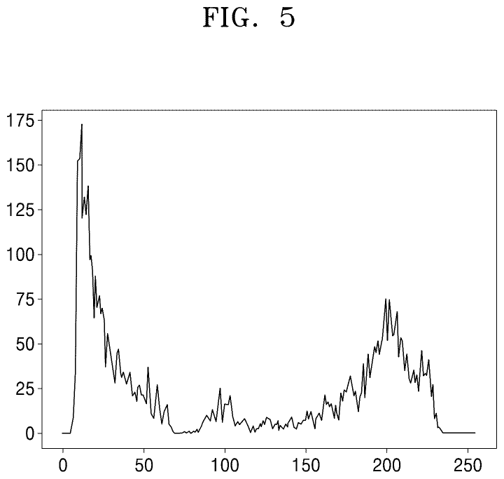

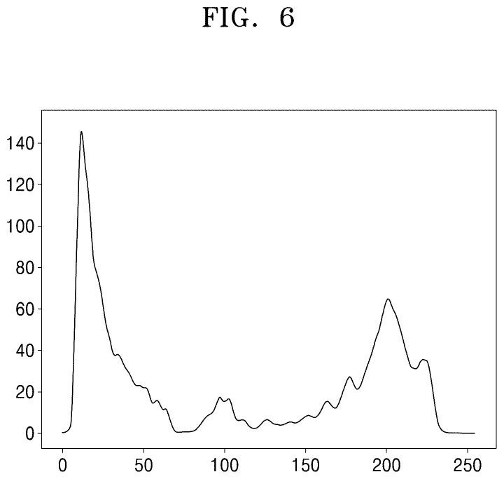

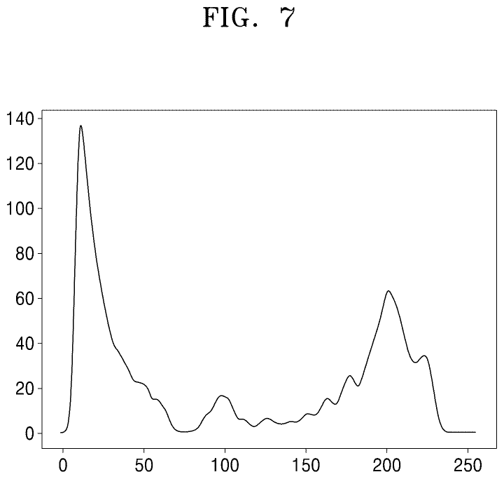

FIG. 4 is an example of a captured image obtained by an optical inspection apparatus, FIG. 5 is a graph showing a histogram of the captured image illustrated in FIG. 4, FIG. 6 is a histogram graph obtained by eliminating noise from the histogram graph illustrated in FIG. 5, and FIG. 7 is a histogram graph obtained by eliminating noise from the histogram graph illustrated in FIG. 6.

FIG. 4 shows a captured image of a device under inspection obtained by an image capturing unit 1300 of the optical inspection apparatus 1000. The device under inspection captured by the image capturing unit 1300 has a form of two stacked wafers (e.g., an upper wafer and a lower wafer). A first mark M1 represents an alignment mark on an upper wafer, and a second mark M2 represents an alignment mark on a lower wafer. The alignment between the upper and lower wafers may be determined based on the position relationship between the first mark M1 and the second mark M2.

FIG. 5 is a graph showing a histogram for the captured image of FIG. 4. The histogram in FIG. 5 shows brightness levels (0-255) on an x-axis and frequency counts of pixels, corresponding to the respective brightness levels, on a y-axis. The histogram includes the overall brightness distribution of the captured image in FIG. 4 together with irregular fluctuations due to noise.

FIG. 6 is a graph showing a result of primarily eliminating the noise from the histogram of FIG. 5. The noise elimination may be performed by using the moving average technique described above, which may make the overall shape of the histogram more apparent. This process removes small variations and may emphasize dominant brightness distribution patterns.

FIG. 7 shows a final histogram graph obtained by secondarily eliminating the noise from the histogram of FIG. 6. The additional noise elimination process makes the main features of the histogram more obvious, which allows for more accurate detection of extreme points. An extreme point, at which a slope change, may be detected in this final histogram and set as a representative brightness value.

This series of histogram processing operations is an essential procedure for calculating an accurate representative brightness value, which enables more reliable image brightness correction. A representative brightness value that more accurately reflects the brightness characteristics of the actual image may be obtained by using a histogram from which noise has been eliminated (or simply referred to as a denoised histogram).

The denoised histogram may be passed to the derivative calculator 113 and used for derivative calculations. The derivative calculator 113 may calculate a more accurate change in slope from a denoised smooth curve.

The derivative may represent the slope at each point on a histogram curve, which enables identification of a rate of change in the histogram.

The derivative calculator 113 may calculate derivatives by using, for example, a central difference method. The central difference method may represent a numerical differentiation method in which a slope is calculated by using values from points before and after a current point as a center.

Specifically, the derivative calculator 113 utilizes the following equation at each position x of the brightness value in the histogram, and a derivative value f′(x) may be calculated by using Equation (1) below.

$${f}^{′} ( x ) = ( f ( x + 1 ) - f ( x - 1 ) ) / 2 \qquad Equation ( 1 )$$

Here, f(x) may denote a histogram value at a brightness value x, and f(x+1) and f(x−1) may denote histogram values at positions x+1 and x−1, respectively.

A forward differentiation method and a backward differentiation method may be used at boundary points x=0 and x=255, respectively, in the histogram. The derivative values may be calculated by using f′(0)=f(1)−f(0) at x=0 and f′(255)=f(255)−f(254) at x=255.

The derivative calculator 113 may store the calculated derivative values in the form of an array. The stored derivative array may have 256 elements, each representing the rate of change of the histogram at a corresponding brightness value position.

A bin with a positive derivative value may represent a bin in which a histogram is increasing, and a bin with a negative derivative value may represent a bin in which a histogram is decreasing. A point with a derivative value of zero may represent an extreme point in the histogram, i.e., a local maximum point or a local minimum point.

The calculated derivative is passed to the representative brightness value-setting unit 114 and may be used to detect the extreme point. The representative brightness value-setting unit 114 may set, as a representative brightness value, a point that satisfies certain conditions among points at which the derivative values become zero.

The representative brightness value-setting unit 114 may set, as the representative brightness value, one of x values for which y values are zero in the graph for the derivative. Specifically, when an x coordinate of the highest point in the histogram corresponding to a primitive function of a derivative is in a range of greater than 127 and less than 255, the representative brightness value-setting unit 114 may set, as the representative brightness value, the smallest x value, among the x values for which the y values of the derivative are zero, in a region in which the x values are greater than 0 and less than 127.

On the other hand, when an x coordinate of the highest point in the histogram is in a range of greater than 0 and less than 127, the representative brightness value-setting unit 114 may set, as the representative brightness value, the largest x value, among the x values for which the y values of the derivative are zero, in a region in which the x values are greater than 127 and less than 255.

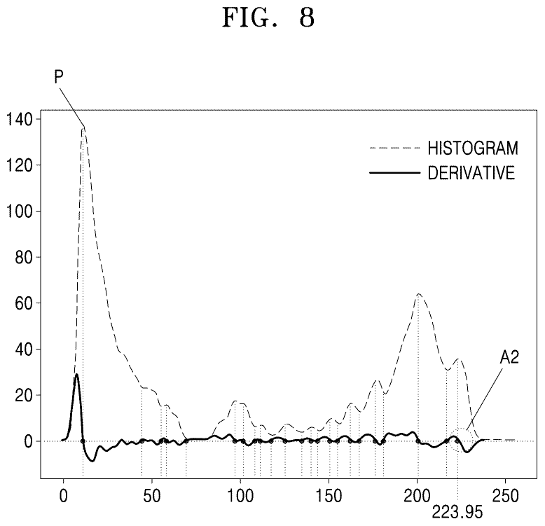

FIG. 8 shows a derivative graph of the histogram graph shown in FIG. 7.

Referring to FIG. 8, a highest point P in the histogram is located in a region in which the x coordinate of the highest point P is greater than 0 and less than 50 on the x-axis, and thus the representative brightness value-setting unit 114 may set 223.95 (A2), which is the largest of the values for which the y values are zero in the derivative graph, as the representative brightness value for the captured image.

The brightness value corrector 120 may correct the representative brightness value such that a difference between the representative brightness value and a preset reference brightness value is within a certain range. For example, the brightness value corrector 120 may set the representative brightness value as a final brightness value when the difference between the representative brightness value and the preset reference brightness value is within the certain range. On the other hand, when the difference between the representative brightness value and the preset reference brightness value is outside the certain range, the brightness value corrector 120 may set a corrected brightness value that is obtained by adding a certain brightness value to the representative brightness value. The certain range may refer to a predetermined range.

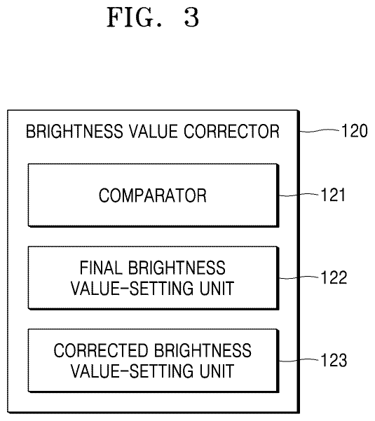

FIG. 3 is a block diagram schematically showing an example of the brightness value corrector 120 illustrated in FIG. 1.

Referring to FIG. 3, the brightness value corrector 120 may include, for example, a comparator 121, a final brightness value-setting unit 122, and a corrected brightness value-setting unit 123.

The comparator 121 may compare the representative brightness value to the reference brightness value. The representative brightness value represents a value set in the representative brightness value calculator 110 as described above, and the reference brightness value represents a preset value. The comparator 121 may determine whether the representative brightness value is greater than or less than the reference brightness value.

When the comparator 121 determines that the difference between the representative brightness value and the reference brightness value is within a certain range, the final brightness value-setting unit 122 may set the representative brightness value as the final brightness value. In this case, the corrected image generator 130 may generate a final image in which the brightness value of the captured image becomes the final brightness value.

However, when the comparator 121 determines that the difference between the representative brightness value and the reference brightness value is outside the certain range, the corrected brightness value-setting unit 123 may set a corrected brightness value that is obtained by adding a certain brightness value to the representative brightness value. In this case, the corrected image generator 130 may generate a corrected image in which the brightness value of the captured image is the brightness value corrected by the brightness value corrector 120. For example, the corrected image generator 130 may form the corrected image in which the brightness value of the captured image becomes the corrected brightness value.

After the corrected image is generated, the representative brightness value calculator 110 may generate a histogram for the corrected image, eliminate noise from the histogram, calculate a derivative of the denoised histogram, and set a representative brightness value for the corrected image from the derivative graph.

The brightness value corrector 120 compares the representative brightness value of the corrected image to the reference brightness value. When a difference between the representative brightness value of the corrected image and a reference brightness value is within the certain range, the representative brightness value may be set as a final brightness value. When the difference between the representative brightness value of the corrected image and the reference brightness value is outside the certain range, a secondarily corrected brightness value may be set by adding a certain brightness value to the representative brightness value.

The certain brightness value that is added to the representative brightness value in order to obtain the secondarily corrected brightness value may be obtained by interpolation. This is described below.

The corrected image generator 130 may generate the final image based on the final brightness value or generate the corrected image based on the corrected brightness value.

FIG. 9 is a block diagram schematically showing the optical inspection apparatus 1000 according to an example embodiment.

Referring to FIG. 9, an optical inspection apparatus 1000 may include, for example, a light source unit 1100, an optical unit 1200, an image capturing unit 1300, a controller 1500, a processor 1400, and a stage 1600.

The light source unit 1100 may include various light sources, such as an LED, a halogen lamp, and laser and may irradiate a device under inspection with uniform and stable light. In an embodiment, the light source unit 1100 may include an LED array that emits white light. The LED array may have a structure in which a plurality of LEDs are arranged in a matrix form, and each LED may be configured to be independently controllable.

The light source unit 1100 may further include a drive circuit for adjusting the light emission intensity of the LEDs. The drive circuit may control current applied to each LED and thus adjust the light emission intensity. The drive circuit may be electrically connected to the controller 1500 and adjust the light emission intensity of the LED in response to a control signal from the controller 1500.

Also, the light source unit 1100 may include a heat dissipation structure for effectively dissipating heat generated by the LEDs. The heat dissipation structure may include a heat sink, a cooling fan, or the like, and maintain the temperature of the LED within a certain range to secure stability of the light source.

The light source unit 1100 may further include a diffusion plate to improve uniformity of the emitted light. The diffusion plate may be located between the LED array and the device under inspection and uniformly diffuse the light from the LEDs. The diffusion plate may include a light-transmissive material, and have a microscopic pattern formed on the surface thereof to increase the diffusion effect of light.

In an embodiment, the light source unit 1100 may be configured to selectively emit light of various wavelengths depending on characteristics of the device under inspection. For example, a multi-LED array including red, green, and blue LEDs is provided, in which each of the LEDs may be controlled independently to emit light of a desired wavelength. This configuration enables effective inspection of various characteristics of the device under inspection.

The light source unit 1100 may also include a photo sensor for monitoring, in real time, the intensity of the light being emitted. The photo sensor may measure an intensity of light emitted by the LED array and feed the intensity of light back to the controller 1500, and the controller 1500 may adjust the light emission intensity of the LEDs in real time on the basis of the feedback.

The optical unit 1200 may include various optical components, and may effectively guide light from the light source unit 1100 to the device under inspection and transmit the light reflected from the device under inspection to the image capturing unit 1300. In an embodiment, the optical unit 1200 may include a lens unit and a beam splitter.

The lens unit may include a plurality of lenses and perform functions of focusing, collimating, or magnifying light. The lens unit may include a focusing lens for focusing light from the light source unit 1100 onto the device under inspection, a collimating lens for collimating the reflected light, and a magnifying lens for magnifying an image of the device under inspection. These lenses may be implemented in a variety of forms, including a spherical lens, an aspherical lens, or a Fresnel lens.

The beam splitter performs a function of reflecting incident light from the light source unit 1100 toward the device under inspection and a function of transmitting reflected light from the device under inspection toward the image capturing unit 1300. In an embodiment, the beam splitter may be implemented as a dichroic mirror that selectively reflects or transmits light of a specific wavelength. Alternatively, the beam splitter may be implemented as a half mirror that reflects a portion of the incident light and transmits the remainder.

The optical unit 1200 may also include a polarizing element for controlling a polarization state of the light. The polarizing element may include a linear polarizer, a circular polarizer, or a phase retardation plate, or the like to analyze the polarization characteristics of the device under inspection.

The lens unit of the optical unit 1200 may be configured to adjust magnification. For example, a zoom lens system may be employed to appropriately adjust the magnification depending on the size of the device under inspection or the region to be inspected. The zoom lens system may be connected to a drive device, such as a motor, and automatically adjust the magnification under control by the controller 1500.

The optical unit 1200 may further include an alignment mechanism for alignment of an optical axis. The alignment mechanism may finely adjust the position and angle of the lens or the beam splitter, enabling precise alignment of an optical system. The alignment mechanism may be configured to be manually or automatically manipulated.

In addition, the optical unit 1200 may include an aperture or a light blocking structure for blocking undesirable scattered or reflected light. These structures may contribute to improving the quality of an inspection image and reducing noise.

Each of the optical components in the optical unit 1200 may be fixed to a stable mount structure to prevent the optical characteristics thereof from being altered by heat or vibration. The mount structure may include a material having a low coefficient of thermal expansion to minimize a change in the position of the optical components due to a change in temperature.

The optical unit 1200 may further include various filters if necessary. For example, there may be provided a band-pass filter for transmitting only specific wavelengths, a neutral-density filter for adjusting the amount of light, or a notch filter for blocking specific wavelengths. These filters may be selectively arranged on an optical path depending on the target to be inspected or the purpose of inspection.

The image capturing unit 1300 may include an image sensor and components associated therewith, and may utilize light reflected from the device under inspection and obtain a captured image. In an embodiment, the image capturing unit 1300 may include a high-resolution charge-coupled device (CCD) or a complementary metal-oxide semiconductor (CMOS) image sensor.

The image sensor converts the light reflected from the device under inspection into an electrical signal, and the obtained image data is transmitted to the processor 1400. The image sensor may be designed to exhibit high sensitivity and low-noise characteristics and have a function of automatically adjusting an exposure time depending on an amount of light.

The image capturing unit 1300 may further include a drive circuit for controlling operation of the image sensor. The drive circuit may control the exposure time, the gain, the frame rate, or the like of the image sensor, and may communicate with the controller 1500 and set optimal image capturing conditions.

Also, the image capturing unit 1300 may include a memory buffer for temporarily storing the obtained image data. The memory buffer may sequentially store images captured at high speed and transmit the images to the processor 1400.

In an embodiment, the image capturing unit 1300 may include a plurality of image sensors and may be configured to simultaneously capture images of different regions on the device under inspection. This configuration may shorten inspection times and improve processing efficiencies.

The stage 1600 may include a conveyance mechanism and a control system and may stably support and precisely move the device under inspection. In an embodiment, the stage 1600 may be configured as a 3-axis conveyance stage capable of moving in an X-axis direction, a Y-axis direction, and a Z-axis direction.

The stage 1600 may include a chuck for holding the device under inspection. The chuck may firmly hold the device under inspection by using a vacuum suction method or a mechanical clamping method. In the case of the vacuum suction method, a plurality of vacuum holes may be formed in the surface of the chuck and connected to a vacuum pump to suction and hold the device under inspection.

The conveyance mechanism for each axis may include drive devices, such as a linear motor, a ball screw, and a piezo actuator. These drive devices may be designed for position control with nanometer-level precision. Each axis may also be equipped with position detection sensors, such as an encoder and a linear scale, to accurately measure the current position of the stage.

The stage 1600 may be further configured to rotate about a θ (theta) axis, and thus, the angle of the device under inspection may be adjusted. A θ-axis rotary mechanism may include a precision rotary motor and a speed reducer and accurately control the rotation angle via an angle sensor.

The stage 1600 may include a vibration damping system and prevent external vibrations from being transmitted to the device under inspection. The vibration damping system may include pneumatic or magnetically levitated damping bars and thus effectively prevent fine vibrations from being transmitted to the stage 1600.

In addition, the stage 1600 may include a limit sensor and an emergency stop system for preventing collisions that may occur during conveyance. The limit sensor may sense a travel limit on each axis and immediately stop motion of the stage in case of emergency.

All operations of the stage 1600 may be controlled by the controller 1500, and an optimal conveyance path may be automatically generated and utilized on the basis of the size of the device under inspection and the inspection region. This may maximize the inspection efficiency and minimize the inspection time.

The controller 1500 is responsible for controlling all operations of the optical inspection apparatus 1000 and managing synchronized operation between components thereof. In an embodiment, the controller 1500 may be implemented as a control system that includes a central processing unit (CPU), memory, and various control circuits.

The controller 1500 may control operation of the light source unit 1100 and set optimal lighting conditions for the inspection. Specifically, a light emission intensity, a light emission time, a light emission pattern, or the like of the LED may be controlled, and the intensity of the light source may be adjusted in real time on the basis of a feedback signal received from the photo sensor.

For the image capturing unit 1300, parameters, such as the exposure time, the gain, and the frame rate of the image sensor, may be controlled to achieve optimal image quality. Also, the timing of image capturing is accurately synchronized with the timing of light emission of the light source unit 1100, and thus, the image may be obtained efficiently.

With respect to the control of the stage 1600, the controller 1500 controls a motor driver for each axis to perform precise position control. The feedback signal from the position detection sensor may be used to perform closed-loop control, thereby achieving nanometer-level precision. Also, the optimal conveyance path is calculated and acceleration/deceleration control is performed, and thus, the efficient inspection is achieved.

The controller 1500 may transmit inspection conditions and parameters that are input to each component via a user interface and may collect and monitor various pieces of data and state information that occur during an inspection process. In case of abnormalities, a warning message may be displayed and necessary safety actions may be performed automatically.

In addition, the controller 1500 may closely cooperate with the processor 1400 to perform feedback control on the basis of inspection results. For example, the intensity of the light source or the exposure conditions of a camera may be automatically adjusted based on the information about the image quality analyzed by the processor 1400.

The controller 1500 may include an inspection recipe management function, and may store inspection conditions for various devices under inspection and retrieve and apply the inspection conditions when needed. Accordingly, an inspection setup time may be reduced and work efficiency may be improved.

In addition, the controller 1500 may perform self-diagnostic and calibration functions for a system. The state of each component is checked regularly and, if necessary, automatic correction is performed to ensure the stability and reliability of the system.

The processor 1400 may have functions of processing the captured image, obtained by the image capturing unit 1300, and analyzing the state of the device under inspection. The processor 1400 may include the image brightness correction module 100 described above. That is, the processor 1400 may generate the histogram of the captured image obtained by the image capturing unit 1300, detect the extreme point, at which the slope changes in the histogram, set the extreme point as the representative brightness value, and correct the brightness of the captured image on the basis of the difference between the representative brightness value and the preset reference brightness value. In an embodiment, the processor 1400 may include a representative brightness value calculator 110, a brightness value corrector 120, and a corrected image generator 130. The representative brightness value calculator 110, the brightness value corrector 120, and the corrected image generator 130 are the same as those described above.

The processor 1400 may further include an image pre-processing function. For example, pre-processing, such as noise elimination, edge enhancement, and image smoothing, may be performed to improve the accuracy of subsequent analysis.

Also, the processor 1400 may perform a function of detecting and classifying defects in the device under inspection by using the corrected image. Deep learning-based defect classification algorithms or traditional image processing techniques may be utilized to automatically identify and classify different types of defects.

The processor 1400 may store the inspection results in a database and may perform statistical analysis to monitor trends in the inspection process. Accordingly, process abnormalities may be sensed in advance and necessary actions may be performed thereon.

Although not illustrated, processor 1400 can include one or more of the following components: at least one processor (e.g., a central processing unit (CPU), a graphic processing unit (GPU), an application processor (AP), an application specific integrated circuit (ASIC), or other processors) configured to execute computer program instructions to perform various processes and methods, random access memory (RAM) and read only memory (ROM) configured to access and store data and information and computer program instructions, input/output (I/O) devices configured to provide input and/or output to the processor 1400 (e.g., keyboard, mouse, display, speakers, printers, modems, network cards, etc.), and storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium) where data and/or instructions can be stored. In addition, the processor 1400 can include antennas, network interfaces that provide wireless and/or wire line digital and/or analog interface to one or more networks over one or more network connections (not shown), a power source that provides an appropriate alternating current (AC) or direct current (DC) to power one or more components of the processor 1400, and a bus that allows communication among the various components of the processor 1400.

The functional modules (or units) of the processor 1400 (e.g., the representative brightness value calculator 110, the brightness value corrector 120, and the corrected image generator 130) may each correspond to a separate segment or segments of software (e.g., a subroutine) which configure the processor 1400, and/or may correspond to segment(s) of software that also correspond to one or more other functional modules (or units) described herein (e.g., the functional modules (or units) may share certain segment(s) of software or be embodied by the same segment(s) of software).

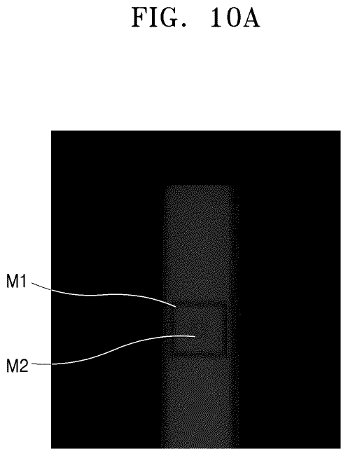

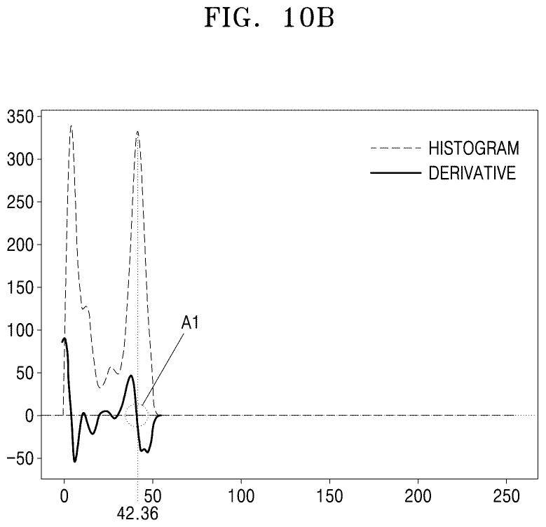

With reference to FIGS. 10A to 12B, a process of image brightness correction of an optical inspection apparatus, according to an example embodiment, is described below.

FIG. 10A is diagram showing a captured image obtained by an optical inspection apparatus. As illustrated in FIG. 10A, the captured image has a very dark brightness value throughout.

FIG. 10B is a diagram showing a histogram graph of the captured image illustrated in FIG. 10A and a derivative graph of the histogram graph. Specifically, in the histogram graph, an x-axis represents a brightness value of a pixel and a y-axis represents the number of pixels having the corresponding brightness value. The histogram graph is in a state in which noise has been eliminated from the histogram generated from the captured image of FIG. 10A by the processor 1400. As shown in FIG. 10B, the histogram graph shows that pixels are distributed only in a range between brightness values of about 0 and about 55, and no pixels are present in a range of greater than a brightness value of 55.

Also, the derivative graph of the histogram graph is also illustrated in FIG. 10B. In the derivative graph, the largest value among the x values for which the y values are zero is 42.36, and this value may be set as a representative brightness value for the captured image illustrated in FIG. 10A. The representative brightness value of 42.36 is less than the reference brightness value of 225, and the difference between the representative brightness value and the reference brightness value is 182.64, which exceeds a certain range of 0.2. Accordingly, the corrected brightness value-setting unit 123 may add a certain brightness value to the representative brightness value and thereby set a corrected brightness value.

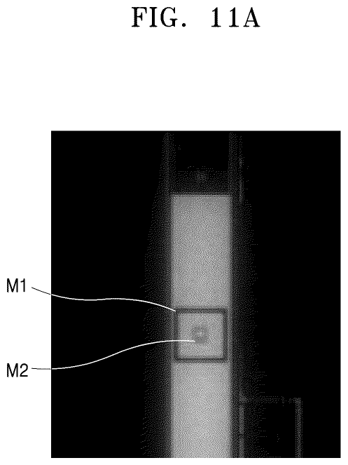

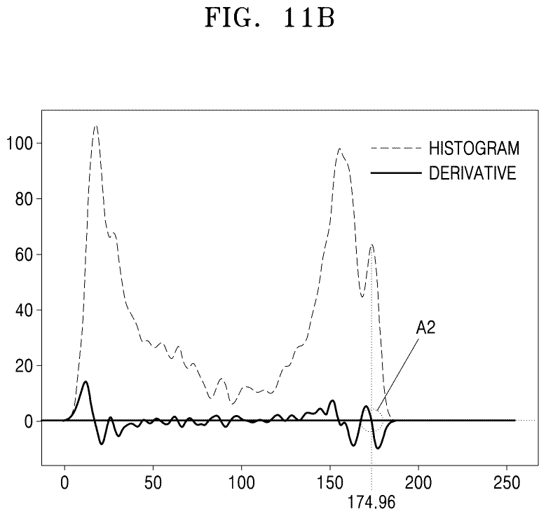

FIG. 11A is a diagram illustrating a corrected captured image that is obtained by primarily correcting the brightness value of the captured image illustrated in FIG. 10A. The corrected captured image of FIG. 11A may be generated by the corrected image generator 130 according to a corrected brightness value that is set by adding a certain brightness value to the representative brightness value 42.36 of FIG. 10A.

FIG. 11B is a diagram showing a histogram graph of the corrected captured image illustrated in FIG. 11A and a derivative graph of the histogram graph. The histogram graph is in a state in which noise has been eliminated from the histogram generated from the corrected captured image of FIG. 11A by the processor 1400. As shown in FIG. 11B, the histogram graph shows that pixels are distributed only in a range between brightness values of about 0 and about 190, and no pixels are present in a range of greater than a brightness value of 190.

In the derivative graph of FIG. 11B, the largest value among the x values for which the y values are zero is 174.96, and the representative brightness value-setting unit 114 may set the value of 174.96 as a representative brightness value for the corrected captured image illustrated in FIG. 11A. The representative brightness value of 174.96 is less than the reference brightness value of 225, and the difference between the representative brightness value and the reference brightness value is 50.04, which exceeds the certain range of 0.2. Accordingly, the corrected brightness value-setting unit 123 may apply a linear interpolation method to the certain brightness value added in the primary correction described above and thus obtain a certain brightness value for secondary correction, and may add the certain brightness value for the secondary correction to the representative brightness value and thereby set a corrected brightness value.

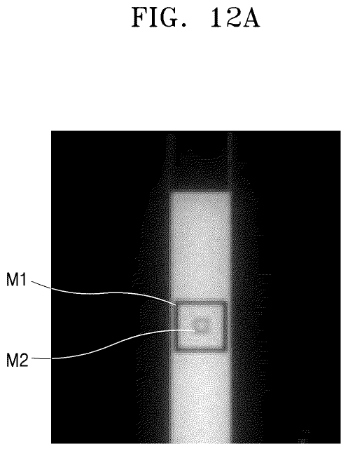

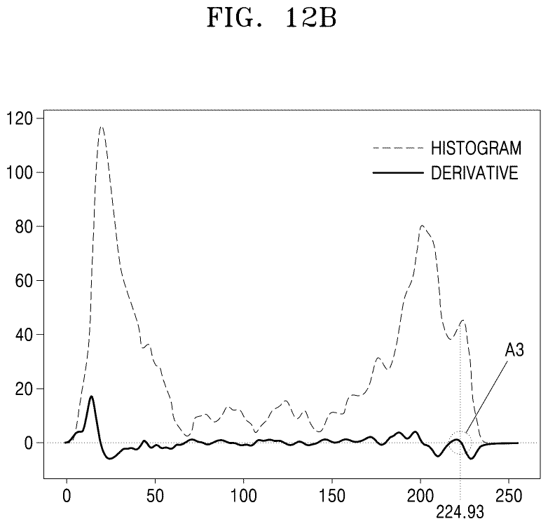

FIG. 12A is a diagram illustrating a corrected captured image that is obtained by secondarily correcting the brightness value of the captured image illustrated in FIG. 11A. The corrected captured image illustrated in FIG. 12A may be generated according to the corrected brightness value that is set by adding the certain brightness value for the secondary correction to the representative brightness value of 174.96 in FIG. 11A.

FIG. 12B is a diagram showing a histogram graph of the corrected captured image illustrated in FIG. 12A and a derivative graph of the histogram graph. The histogram graph is in a state in which noise has been eliminated from the histogram generated from the corrected captured image of FIG. 12A by the processor 1400. As shown in FIG. 12B, the histogram graph shows that pixels are distributed only in a range between brightness values of about 0 and about 240, and no pixels are present in a range of greater than a brightness value of 240.

In the derivative graph of FIG. 12B, the largest value among the x values for which the y values are zero is 224.93, and this value may be set, by the representative brightness value-setting unit 114, as a representative brightness value for the corrected captured image illustrated in FIG. 12A. The representative brightness value of 224.93 is less than the reference brightness value of 225, and the difference between the representative brightness value and the reference brightness value is 0.07, which is within the certain range of 0.2. Accordingly, the final brightness value-setting unit 122 may set the representative brightness value of 224.93 as the final brightness value.

The corrected image generator 130 may generate a final image according to the representative brightness value of 224.93.

The optical inspection apparatus 1000 according to an embodiment may automatically correct the brightness of the captured images to obtain inspection images having consistent quality without requiring manual operation by an inspector, thereby improving the reliability and efficiency of the inspection.

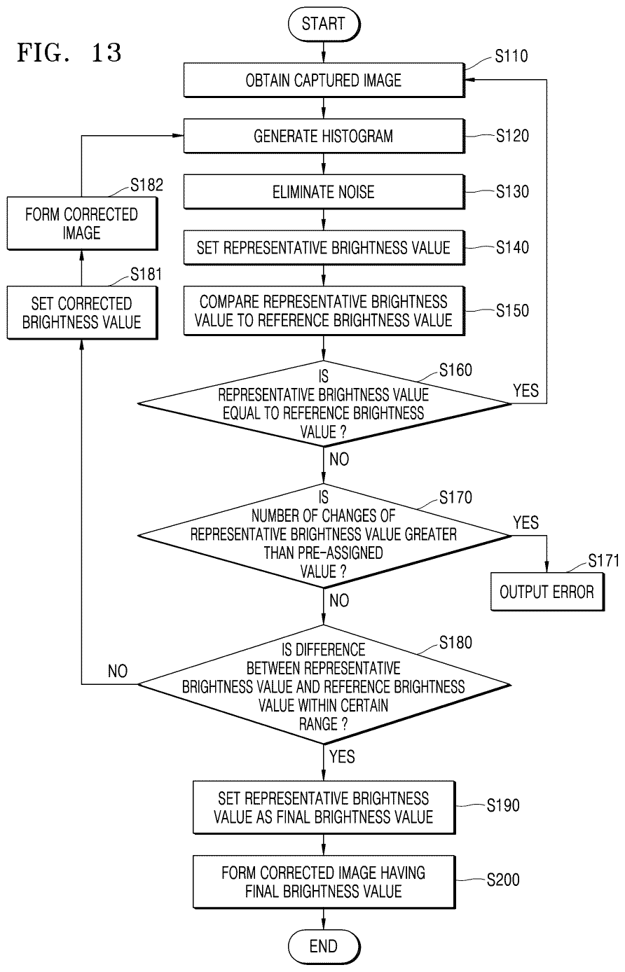

FIG. 13 is a flowchart schematically showing an image brightness correction method according to an example embodiment.

Referring to FIG. 13, the image brightness correction method according to an embodiment may include obtaining a captured image (S110), generating a histogram (S120), eliminating noise (S130), setting a representative brightness value (S140), comparing the representative brightness value to a reference brightness value (S150), identifying whether the representative brightness value is equal to the reference brightness value (S160), identifying whether the number of changes of the representative brightness value is greater than a pre-assigned value (S170), identifying whether a difference between the representative brightness value and the reference brightness value is within a certain range (S180), setting the representative brightness value as a final brightness value (S190), and forming a final image (S200).

During the obtaining of the captured image (S110), an image capturing unit 1300 of an optical inspection apparatus 1000 may be utilized to obtain the captured image of a device under inspection. More specifically, light emitted from a light source unit 1100 may be reflected from the device under inspection, pass through an optical unit 1200, and be converted to an electrical signal via an image sensor in the image capturing unit 1300. Here, a controller 1500 may control parameters, such as light intensity of the light source unit 1100, an exposure time of the image capturing unit 1300, and a gain, to obtain an optimal image. The stage 1600 may hold the device under inspection in a correct position to ensure that a clear image is obtained. The obtained captured image may be transmitted, in a digital format, to a processor 1400 and utilized as basic data for subsequent processing operations.

During the generating of the histogram (S120), the processor 1400 may analyze distribution of pixel values of the obtained captured image and generate the histogram. The histogram may be represented as a two-dimensional graph in which an x-axis represents brightness levels (0-255) and a y-axis represents the number of pixels having the corresponding brightness levels. The histogram may be formed by scanning the brightness value of each pixel and increasing a frequency count of the corresponding brightness level. Here, the total number of pixels in the image is maintained, and only the distribution over brightness levels may be represented. The generated histogram may be used to identify the overall brightness characteristics of the image and utilized as basic data for subsequent processing.

During the eliminating of the noise (S130), unnecessary noise contained in the generated histogram may be eliminated. Smoothing processing may be performed to eliminate noise in the histogram. This may involve applying filtering techniques, such as a moving average and a Gaussian filter, to reduce sudden fluctuations in the histogram. A primary noise elimination process may eliminate small-scale fluctuations, and a secondary noise elimination process may further eliminate medium-scale fluctuations. Accordingly, main patterns in the histogram become apparent, and extreme points may be more accurately detected. The noise elimination process may be designed to eliminate only unnecessary fluctuations while preserving important features of original data.

During the setting of the representative brightness value (S140), the extreme points at which a change in slope occurs in the denoised histogram may be detected. The detection of extreme points may be performed by finding a point at which the sign of the slope of the histogram curve changes or by finding a point at which a first-order derivative value becomes zero. The point that is most representative among the detected extreme points may be selected and set as the representative brightness value. The determination of representativeness may be made by comprehensively considering the distribution of pixels around the extreme points, the amounts of changes in slope at the extreme points, and the like. The representative brightness value set described above may be used as a value representative of the overall brightness characteristics of the image.

During the comparing of the representative brightness value to the reference brightness value (S150), the set representative brightness value may be compared to the reference brightness value that is preset in a system. The reference brightness value represents an expected brightness level of the image under normal inspection conditions and may be set during a system calibration process. During the comparison process, not only an absolute difference between two values is considered, but also a range of allowable errors. This operation may determine if the current image has adequate brightness and may provide basic data for performing corrections if necessary. The comparison results may be used as a determination reference for subsequent operations.

During the identifying whether the representative brightness value is equal to the reference brightness value (S160), it may be identified whether the representative brightness value is equal to the reference brightness value. When the representative brightness value is equal to the reference brightness value, the image brightness correction method may return to operation (S110) to obtain another captured image. When not equal, the image brightness correction method may proceed to a next operation. This may have the effect of preventing unnecessary correction when the brightness of the image is already at an appropriate level, and allowing a new image to be inspected.

During the identifying whether the number of changes of the representative brightness value is greater than a pre-assigned value (S170), it may be identified whether the number of corrections of the representative brightness value exceeds a pre-assigned value. When the number of corrections of the representative brightness value exceeds the pre-assigned value, an error message may be output and the correction process may be terminated. This may be to avoid infinite correction trials and to ensure system stability. The limit on the number of corrections may be set appropriately on the basis of the characteristics and requirements of the system.

During the identifying whether the difference between the representative brightness value and the reference brightness value is within the certain range (S180), it may be identified whether the difference between the two values is within an allowable range. When the difference between the two values is outside a certain range, a corrected brightness value is set (S181). Accordingly, a corrected image is formed (S182), and then the generating of the histogram (S120) may proceed again with respect to the corrected image. The process above may be to perform corrections repeatedly so that the brightness of the image reaches the desired level. During the correction process, the amount of correction may be determined by a linear interpolation method.

During the setting of the representative brightness value as the final brightness value (S190), the current representative brightness value may be set as the final brightness value when the difference between the representative brightness value and the reference brightness value is within a certain range. This indicates that the correction process has been successfully completed, and the set final brightness value may be used for subsequent image correction. The final brightness value may represent a value that adequately reflects the brightness characteristics of the image while satisfying criteria required by the system.

During the forming of the final image (S200), the final image may be formed by correcting the brightness of the captured image on the basis of the set final brightness value. During this process, the brightness value of each pixel may be adjusted by using a look-up table or a linear/nonlinear transformation function. The final image may have an appropriate brightness level while preserving important features of an original image. The final image formed above may be used in subsequent inspection processes or analyses and may improve the accuracy and reliability of the inspection.

Through the image brightness correction method, the optical inspection apparatus may provide stable and reliable inspection results. In particular, automated correction processes and various safety devices enable efficient and reliable inspection.

While the inventive concept has been particularly shown and described with reference to embodiments thereof, it will be understood that various changes in form and details may be made therein without departing from the spirit and scope of the following claims.

What is claimed is:

1. An image brightness correction module comprising:
a representative brightness value calculator configured to calculate a representative brightness value for a captured image of a device under inspection;
a brightness value corrector configured to correct the representative brightness value so that a difference between the representative brightness value and a preset reference brightness value is within a certain range; and
a corrected image generator configured to form a corrected image having a corrected brightness value, wherein a brightness value of the captured image is corrected to the corrected brightness value by the brightness value corrector,
wherein the representative brightness value represents a grayscale level value at an extreme point in a histogram of the captured image, and
wherein in the histogram, an x-axis represents a grayscale level value of the captured image and a y-axis represents a number of pixels corresponding to the grayscale level value of the captured image.

2. The image brightness correction module of claim 1, wherein the representative brightness value calculator comprises:
a histogram generator configured to generate the histogram from the captured image;
a noise eliminator configured to eliminate noise from the histogram;
a derivative calculator configured to calculate a derivative for the histogram from which the noise has been eliminated; and
a representative brightness value-setting unit configured to set, as the representative brightness value, one of x values for which y values are zero in a graph for the derivative.

3. The image brightness correction module of claim 2, wherein the histogram generator utilizes an OpenCV library to generate the histogram for the captured image.

4. The image brightness correction module of claim 2, wherein the noise eliminator utilizes a smoothing technique to eliminate the noise of the histogram.

5. The image brightness correction module of claim 2, wherein the noise eliminator utilizes a moving average technique to eliminate the noise of the histogram.

6. The image brightness correction module of claim 2, wherein the representative brightness value-setting unit is configured to:
when an x coordinate of a highest point in a histogram corresponding to a primitive function of the derivative is in a range of greater than 127 and less than 255, a smallest x value, among x values for which y values of the derivative are zero, in a region in which the x values are greater than 0 and less than 127 is set as the representative brightness value; and
when an x coordinate of a highest point in a histogram corresponding to a primitive function of the derivative is in a range of greater than 0 and less than 127, a largest x value, among x values for which y values of the derivative are zero, in a region in which the x values are greater than 127 and less than 255 is set as the representative brightness value.

7. The image brightness correction module of claim 1, wherein the brightness value corrector comprises:
a comparator configured to compare the representative brightness value to the preset reference brightness value;
a final brightness value-setting unit configured to set the representative brightness value as a final brightness value when the difference between the representative brightness value and the preset reference brightness value is within a certain range; and
a corrected brightness value-setting unit configured to set a corrected brightness value when the difference between the representative brightness value and the preset reference brightness value is outside of the certain range, wherein the corrected brightness value is obtained by adding a certain brightness value to the representative brightness value.

8. The image brightness correction module of claim 7, wherein the corrected image generator is configured to:
form a final image in which the brightness value of the captured image becomes the final brightness value; and
form a corrected image in which the brightness value of the captured image becomes the corrected brightness value.

9. An optical inspection apparatus comprising:
a light source unit configured to emit light;
an optical unit configured to guide the light from the light source unit to a device under inspection;
an image capturing unit configured to obtain a captured image of the device under inspection by using light reflected from the device under inspection;
a controller configured to control operations of the light source unit and the image capturing unit; and
a processor configured to generate a histogram of the captured image obtained by the image capturing unit, detect an extreme point, at which a slope changes in the histogram, to set the extreme point as a representative brightness value, and, based on a difference between the representative brightness value and a preset reference brightness value, correct brightness of the captured image,
wherein the representative brightness value represents a grayscale level value at the extreme point in the histogram of the captured image.

10. The optical inspection apparatus of claim 9, wherein, in the histogram, an x-axis represents a grayscale level value of the captured image and a y-axis represents a number of pixels corresponding to the grayscale level value of the captured image.

11. The optical inspection apparatus of claim 9, wherein the processor comprises:
a representative brightness value calculator configured to calculate the representative brightness value for the captured image of the device under inspection;
a brightness value corrector configured to correct the representative brightness value so that a difference between the representative brightness value and the preset reference brightness value is within a certain range; and
a corrected image generator configured to form a corrected image having a corrected brightness value, wherein a brightness value of the captured image is corrected to the corrected brightness value by the brightness value corrector.

12. The optical inspection apparatus of claim 11, wherein the representative brightness value calculator comprises:
a histogram generator configured to generate the histogram from the captured image;
a noise eliminator configured to eliminate noise from the histogram;
a derivative calculator configured to calculate a derivative for the histogram from which the noise has been eliminated; and
a representative brightness value-setting unit configured to set, as the representative brightness value, one of x values for which y values are zero in a graph for the derivative.

13. The optical inspection apparatus of claim 12, wherein the histogram generator utilizes an OpenCV library to generate the histogram for the captured image.

14. The optical inspection apparatus of claim 12, wherein the noise eliminator utilizes a smoothing technique to eliminate the noise of the histogram.

15. The optical inspection apparatus of claim 12, wherein the noise eliminator utilizes a moving average technique to eliminate the noise of the histogram.

16. The optical inspection apparatus of claim 12, wherein the representative brightness value-setting unit is configured to:
when an x coordinate of a highest point in a histogram corresponding to a primitive function of the derivative is in a range of greater than 127 and less than 255, a smallest x value, among x values for which y values of the derivative are zero, in a region in which the x values are greater than 0 and less than 127, is set as the representative brightness value; and
when an x coordinate of a highest point in a histogram corresponding to a primitive function of the derivative is in a range of greater than 0 and less than 127, a largest x value, among x values for which y values of the derivative are zero, in a region in which the x values are greater than 127 and less than 255, is set as the representative brightness value.

17. The optical inspection apparatus of claim 11, wherein the brightness value corrector comprises:
a comparator configured to compare the representative brightness value to the preset reference brightness value;
a final brightness value-setting unit configured to set the representative brightness value as a final brightness value when the difference between the representative brightness value and the preset reference brightness value is within a certain range; and
a corrected brightness value-setting unit configured to set a corrected brightness value when the difference between the representative brightness value and the preset reference brightness value is outside of the certain range, wherein the corrected brightness value is obtained by adding a certain brightness value to the representative brightness value.

18. An optical inspection apparatus comprising:
a light source unit configured to emit light;
an optical unit configured to guide the light from the light source unit to a device under inspection;
a stage configured to support the device under inspection;
an image capturing unit configured to obtain a captured image of the device under inspection by using light reflected from the device under inspection;
a controller configured to control operations of the light source unit, the stage, and the image capturing unit; and
a processor configured to process the captured image obtained by the image capturing unit,
wherein the processor comprises:
a histogram generator configured to generate a histogram from the captured image;
a noise eliminator configured to eliminate noise from the histogram;
a derivative calculator configured to calculate a derivative for the histogram from which the noise has been eliminated;
a representative brightness value-setting unit configured to set, as a representative brightness value, one of x values for which y values are zero in a graph for the derivative;
a comparator configured to compare the representative brightness value to a reference brightness value;
a final brightness value-setting unit configured to set the representative brightness value as a final brightness value when a difference between the representative brightness value and the reference brightness value is within a certain range;
a corrected brightness value-setting unit configured to set a corrected brightness value when the difference between the representative brightness value and the reference brightness value is outside of the certain range, wherein the corrected brightness value is obtained by adding a certain brightness value to the representative brightness value; and
a corrected image generator configured to form a corrected image having the final brightness value or the corrected brightness value, wherein a brightness value of the captured image is set to the final brightness value or the corrected brightness value,
wherein the representative brightness value represents a grayscale level value at an extreme point in the histogram of the captured image, and
wherein in the histogram, an x-axis represents a grayscale level value of the captured image and a y-axis represents a number of pixels corresponding to the grayscale level value of the captured image.

19. The optical inspection apparatus of claim 18, wherein the representative brightness value-setting unit is configured to:
when an x coordinate of a highest point in a histogram corresponding to a primitive function of the derivative is in a range of greater than 127 and less than 255, a smallest x value, among x values for which y values of the derivative are zero, in a region in which the x values are greater than 0 and less than 127, is set as the representative brightness value; and
when an x coordinate of a highest point in a histogram corresponding to a primitive function of the derivative is in a range of greater than 0 and less than 127, a largest x value, among x values for which y values of the derivative are zero, in a region in which the x values are greater than 127 and less than 255, is set as the representative brightness value.

20. The optical inspection apparatus of claim 18, wherein the noise eliminator utilizes a moving average technique to eliminate the noise of the histogram.
